(19) United States
(12) Patent Application Publication
(10) Pub. No.: US 2022/0319296 A1
(43) Pub. Date: Oct. 6, 2022

(54) SMART SENSOR AND SMART SENSING METHOD USING THE SAME

(71) Applicant: ELSSEN CO., LTD., Daejeon (KR)

(72) Inventor: Jiman PARK, Daejeon (KR)

(21) Appl. No.: 17/623,410

(22) PCT Filed: Aug. 30, 2021
(86) PCT No.: PCT/KR2021/011632

§ 371 Date: Dec. 28, 2021

(30) Foreign Application Priority Data
Dec. 7, 2020 (KR) 10-2020-0169363

(51) Int. Cl. G08B 21/18

(52) U.S. Cl. CPC G08B 21/18

(57) ABSTRACT

The present disclosure relates to a smart sensor for quickly determining a malfunction diagnosis, a risk, and a normal situation in a sensor itself and a smart sensing method using the same. To this end, the smart sensor includes at least one sensing unit configured to collect change information on a field; a communicator configured to transmit the collected change information in time series order; a sensing storage configured to store characteristic information of the sensing unit, reference information that is a target to be compared with information based on the characteristic information or the change information, and the change information; and a controller configured to calculate at least sensing change rate information among the sensing change rate information of the change information according to a sensing time of the change information, sensing pattern information according to the change information, and sensing characteristic change information that varies according to a field characteristic, and to analyze and compare information based on the change information with the reference information.

### TECHNICAL FIELD

The present disclosure relates to a smart sensor and a smart sensing method using the same, and more particularly, to a smart sensor for quickly determining a malfunction diagnosis, a risk, and a normal situation in a sensor itself and a smart sensing method using the same.

### RELATED ART

In general, a large number of sensors are present. By acquiring an accurate and stable sensor value from such a sensor and analyzing a signal received from the sensor, a user may analyze various situations and may respond to emergencies.

Here, in the current times in which a communication system is developed, a measured sensor value is delivered from a sensor device to a server through a communication gateway and the server analyzes sensor data and appropriately provides information thereof to a relevant person to perform various services.

A hyper connection system transmits most of sensor to a server and processes a response in various forms based on analyzed information. In this communication process, a response time may be delayed and communication may be poor, which may lead to data loss.

In this case, if a risk on the field corresponds to an emergency situation, a serious problem may arise. That is, it may cause serious damage to life and property depending on a service.

### DETAILED DESCRIPTION

### Object

The present disclosure is conceived to solve the aforementioned issues and provides a smart sensor for quickly determining a malfunction diagnosis, a risk, and a normal situation in a sensor itself and a smart sensing method using the same.

### Solution

According to an example embodiment to accomplish the aforementioned objects of the present disclosure, a smart sensor according to the present disclosure includes at least one sensing unit configured to collect change information on a field; a communicator configured to transmit the collected change information in time series order; a sensing storage configured to store characteristic information of the sensing unit, reference information that is a target to be compared with information based on the characteristic information or the change information, and the change information; and a controller configured to calculate at least sensing change rate information among the sensing change rate information of the change information according to a sensing time of the change information, sensing pattern information according to the change information, and sensing characteristic change information that varies according to the field characteristic, and to analyze and compare information based on the change information with the reference information.

Here, the sensing storage includes a sensor characteristic unit configured to store the characteristic information of the sensing unit, the characteristic information of the sensing unit including a validity period of the sensing unit; a reference storage unit configured to store the reference information, the reference information including a risk level that is an evaluation index, event information for each risk level, critical information for each risk level, critical time for each risk level, and critical change rate information for each risk level; and a temporary storage configured to store a use period of the sensing unit, the change information, the sensing time of the change information, and sensing change rate information of the change information according to the sensing time.

Also, the controller includes an event manager configured to compare the event information and the change information and to generate an event; a time counter configured to calculate the use period of the sensing unit and to count the sensing time of the change information according to occurrence of the event; a sensing value analyzer configured to compare the critical information for each risk level and the change information and to determine a safety status according to the risk level; a sensing value change calculator configured to calculate the sensing change rate information of the change information according to the sensing time; a sensing value change analyzer configured to compare the critical change rate information for each risk level and the sensing change rate information and to analyze a stability status according to the risk level; and a validity period analyzer configured to compare the validity period of the sensing unit and the use period of the sensing unit and to analyze the stability status according to the risk level.

Here, the reference information further includes standard pattern information according to the critical information and a standard analysis time for the standard pattern information, and the temporary storage is configured to further store the sensing pattern information according to the change information based on the standard analysis time.

Also, the controller further includes a sensing pattern calculator configured to calculate the sensing pattern information based on the standard analysis time; and a sensing pattern analyzer configured to compare the standard pattern information and the sensing pattern information and to analyze the stability status according to the risk level.

Here, the characteristic information of the sensing unit further includes unique information of the sensing unit, the reference information further includes standard characteristic change information based on the unique information of the sensing unit, and the temporary storage is configured to further store the sensing characteristic change information that varies according to the field characteristic.

Also, the controller further includes a sensing characteristic change calculator configured to calculate the sensing characteristic change information that varies according to the field characteristic; and a sensing characteristic change analyzer configured to compare the standard characteristic change information and the sensing characteristic change information and to analyze a safety status according to the risk level.

A smart sensing method according to the present disclosure is a smart sensing method using a smart sensor according to the present disclosure and includes a sensing operation of collecting the change information on the field through the sensing unit; a time counting operation of counting the sensing time of the change information by going through the sensing operation; a sensing value comparison operation of comparing the critical information for each risk level in the reference information and the change information; a first change calculation operation of calculating the sensing change rate information of the change information according to the sensing time after going through the sensing value comparison operation; a first comparison operation of comparing the critical change rate information for each risk level in the reference information and the sensing change rate information; a period calculation operation of calculating the use period of the sensing unit after going through the first comparison operation; and a period comparison operation of comparing a validity period of the sensing unit in the characteristic information of the sensing unit and the use period of the sensing unit.

Here, when the risk level is included in a preset safety assumption range as a comparison result of the sensing value comparison operation, a temporary safety signal is generated and the first change calculation operation is performed, when the risk level is included in a preset first safety range as a comparison result of the first comparison operation, a first safety signal is generated and the period calculation operation is performed, and when the use period of the sensing unit is included in the validity period of the sensing unit in the characteristic information of the sensing unit as a comparison result of the period comparison operation, a third safety signal is generated and returning to the sensing operation is performed.

Here, when the risk level is out of the preset safety assumption range as the comparison result of the sensing value comparison operation, a temporary risk signal is generated and the first change calculation operation is performed, when the risk level is out of the preset first safety range as the comparison result of the first comparison operation, a first risk signal is generated and the period calculation operation is performed, when the use period of the sensing unit is out of the validity period of the sensing unit in the characteristic information of the sensing unit as the comparison result of the period comparison operation, a third risk signal is generated, and when at least one risk signal among the temporary risk signal, the first risk signal, and the third risk signal is generated, a corresponding risk signal is transmitted to a server that communicates with the smart sensor.

The smart sensing method according to the present disclosure further includes a time verification operation of comparing the standard analysis time for the standard pattern information according to the critical information and the sensing time of the change information after going through the first comparison operation; a pattern calculation operation of, when the sensing time of the change information is greater than or equal to the standard analysis time as a comparison result of the time verification operation, calculating the sensing pattern information according to the change information based on the standard analysis time; and a pattern comparison operation of comparing the standard pattern information and the sensing pattern information after going through the pattern calculation operation.

Here, when the risk level is included in a preset second safety range as a comparison result of the pattern comparison operation, a second safety signal is generated and the period calculation operation is performed.

Here, when the sensing time of the change information is less than the standard analysis time as the comparison result of the time verification operation, the change information collected according to time series is updated and stored and then returning to the sensing operation is performed.

Here, when the risk level is out of the preset second safety range as the comparison result of the pattern comparison operation, a second risk signal is generated and the period calculation operation is performed.

The smart sensing method according to the present disclosure further includes a second change calculation operation of calculating the sensing characteristic change information that varies according to the field characteristic after going through the period comparison operation; and a characteristic change comparison operation of comparing the standard characteristic change information and the sensing characteristic change information after going through the second change calculation operation.

Here, when the risk level is included in a fourth safety range as the comparison result of the characteristic change comparison operation, a fourth safety signal is generated and returning to an initial operation is performed.

The smart sensing method according to the present disclosure further includes a field inspection operation of, when the risk level is out of a preset fourth safety range as the comparison result of the characteristic change comparison operation, generating a fourth risk signal and inducing field inspection.

A smart sensing method according to the present disclosure is a smart sensing method using a smart sensor according to the present disclosure includes a sensing operation of collecting the change information on the field through the sensing unit; a time counting operation of counting the sensing time of the change information by going through the sensing operation; a sensing value comparison operation of comparing critical information for each risk level in the reference information and the change information; a first change calculation operation of calculating the sensing change rate information of the change information according to the sensing time after going through the sensing value comparison operation; a first comparison operation of comparing the critical change rate information for each risk level in the reference information and the sensing change rate information; a time verification operation of comparing the standard analysis time for the standard pattern information according to the critical information and the sensing time of the change information after going through the first comparison operation; a pattern calculation operation of, when the sensing time of the change information is equal to or greater than the standard analysis time as a comparison result of the time verification operation, calculating the sensing pattern information according to the change information based on the standard analysis time; and a pattern comparison operation of comparing the standard pattern information and the sensing pattern information after going through the pattern calculation operation.

Here, when the risk level is included in a preset safety assumption range as a comparison result of the sensing value comparison operation, a temporary safety signal is generated and the first change calculation operation is performed, when the risk level is included in a preset first safety range as a comparison result of the first comparison operation, a first safety signal is generated and the period calculation operation is performed, and when the risk level is included in a preset second safety range as a comparison result of the pattern comparison operation, a second safety signal is generated.

### Effect

According to a smart sensor and a smart sensing method using the same according to the present disclosure, it is possible to quickly determine a malfunction diagnosis, a risk, and a normal situation in a sensor itself.

Also, according to the present disclosure, since a simple algorithm is configured and applied to a sensor, it is possible to quickly respond to a situation.

Also, according to the present disclosure, contextual information according to a situational response may be transmitted to a server with an excellent computing ability and the server may match the contextual information to information transmitted from another sensor and may precisely determine the contextual information accordingly.

Also, according to the present disclosure, it is possible to quickly determine a malfunction diagnosis, a risk, and a normal situation in a sensor itself based on critical information for each risk level, critical change rate information for each risk level, and a validity period of a sensing unit through a detailed configuration of a storage and a controller.

Also, according to the present disclosure, it is possible to improve judgement power of a sensor itself based on standard pattern information added through a detailed configuration of a sensing storage and a controller.

Also, according to the present disclosure, it is possible to improve judgement power of a sensor itself based on standard characteristic change information added through a detailed configuration of a sensing storage and a controller.

Also, according to the present disclosure, it is possible to clearly determine a situation in a sensor itself by determining priority in change information collected by at least two sensing units through a target setting unit.

Also, according to the present disclosure, it is possible to count abnormality of sensing characteristic change information and to induce smooth inspection on a field through a sensing abnormality counter.

Also, according to the present disclosure, since sequential comparison and analysis is performed based on critical information for each risk level, critical change rate information for each risk level, and a validity period of a sensing unit, it is possible to quickly determine a normal situation in a sensor itself in response to a safety signal.

Also, since the present disclosure further includes an event operation, it is possible to clarify a sensing operation for comparison and analysis in a sensor itself and to prevent an operation of the sensor itself from being deteriorated.

Also, according to the present disclosure, since sequential comparison and analysis is performed based on critical information for each risk level, critical change rate information for each risk level, and a validity period of a sensing unit, it is possible to quickly determine a malfunction diagnosis and a risk situation in a sensor itself and to perform a rapid propagation in response to a safety signal.

Also, according to the present disclosure, since sequential comparison and analysis is performed based on standard pattern information, it is possible to improve judgement power for a normal situation in a sensor itself in response to a safety signal.

Also, according to the present disclosure, it is possible to stably collect change information in time series order to correspond to a standard analysis time and to stabilize collection of change information according to a risk level.

Also, according to the present disclosure, since sequential comparison and analysis is performed based on standard pattern information, it is possible to improve judgement power for a malfunction diagnosis and a risk situation in a sensor itself in response to a safety signal.

Also, according to the present disclosure, since sequential comparison and analysis is performed based on standard characteristic change information, it is possible to improve judgement power for a normal situation in a sensor itself in response to a safety signal.

Also, according to the present disclosure, since sequential comparison and analysis is performed based on standard characteristic change information, it is possible to improve judgement power for a malfunction diagnosis and a risk situation in a sensor itself in response to a risk signal.

Also, according to the present disclosure, it is possible to count abnormality of sensing characteristic change information through an abnormality frequency counting operation and to induce smooth inspection on a field.

Also, according to the present disclosure, it is possible to facilitate replacement in response to a malfunction of at least a sensing unit based on a result of a field inspection operation and to maintain at least the sensing unit in a stable normal condition.

### BRIEF DESCRIPTION OF DRAWINGS

FIG. 1 is a diagram illustrating a communication structure of a smart sensor according to an example embodiment of the present disclosure.

FIG. 2 is a diagram illustrating a storage in a smart sensor according to an example embodiment of the present disclosure.

FIG. 3 is a diagram illustrating a controller in a smart sensor according to an example embodiment of the present disclosure.

FIG. 4 is a graph showing critical information for each sensing time over change information of a smart sensor according to an example embodiment of the present disclosure.

FIG. 5 is a simulation diagram for comparison between standard pattern information and sensing pattern information in a smart sensor according to an example embodiment of the present disclosure.

FIG. 6 is a graph showing sensing intensity for each analysis time in a smart sensor according to an example embodiment of the present disclosure.

FIG. 7 is a flowchart illustrating a smart sensing method according to an example embodiment of the present disclosure.

### MODE

Hereinafter, example embodiments of a smart sensor and a smart sensing method using the same according to the present disclosure are described. Here, the present disclosure is not limited thereto or restricted thereby. Also, detailed description related to a known function or configuration in describing the present disclosure may be omitted for clarity of the present disclosure.

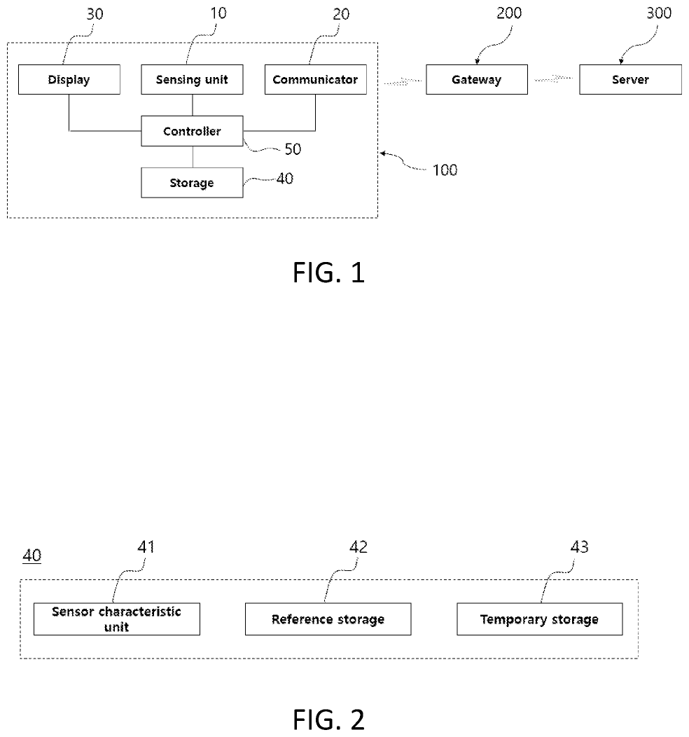

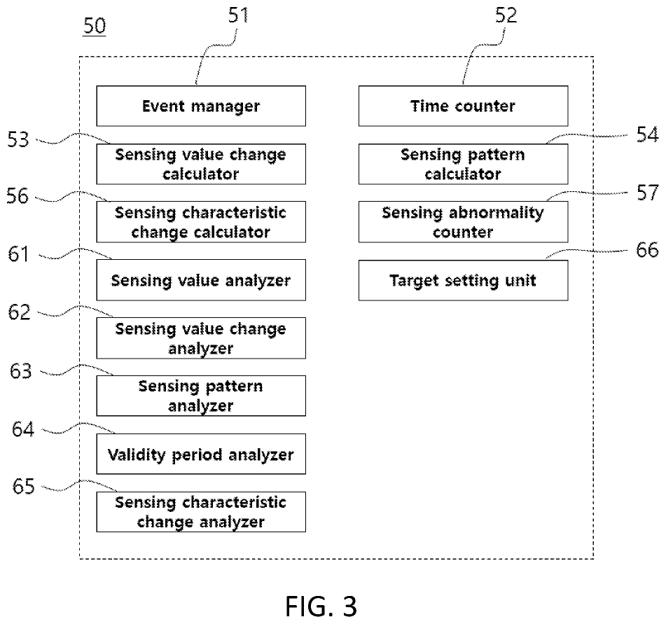

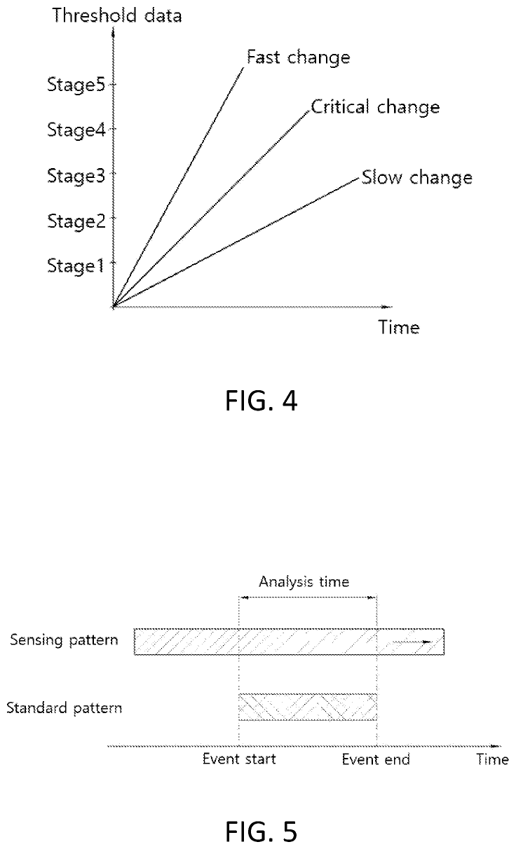

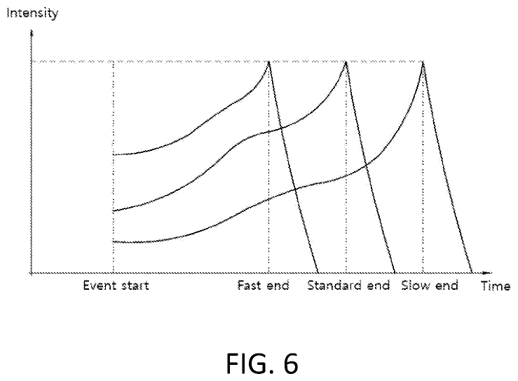

Referring to FIGS. 1 to 6, a smart sensor 100 according to an example embodiment of the present disclosure may include a sensing unit 10, a communicator 20, a storage 40, and a controller 50.

Here, reference numeral 30 represents a display for propagation to a user such that the user may verify with one of a visual sense, an auditory sense, and a tactile sense in response to an operating state of a sensing unit, an operating state of a storage, and an operating state of a controller.

The sensing unit 10 collects change information. At least one sensing unit 10 may be provided.

The communicator 20 transmits the collected change information in time series order. The communicator 20 may transmit the collected change information through at least one communication scheme of a wired communication and a wireless communication. The change information transmitted from the communicator 20 may be delivered to a server 300 through a gateway 200 and the server 300 may monitor the change information.

The communicator 20 may deliver, to the server 300, information stored in a temporary storage 43 of the sensing storage 40, which is described below. The server 300 may collect and manage information transmitted through the communicator 20 and may monitor the collected information.

The communicator 20 may receive, from the server 300, information stored in a reference storage 42 of the sensing storage 40, which is described below. The reference storage 42 may update the existing information by updating the information transmitted from the server 300.

The sensing storage 40 may store characteristic information of the sensing unit 10, reference information that is a target to be compared with information based on the characteristic information or the change information, and the change information.

The sensing storage 40 may include a sensor characteristic unit 41 configured to store the characteristic information of the sensing unit 10, the reference storage 42 configured to store the reference information, and the temporary storage 43 configured to store the change information. The characteristic information of the sensing unit 10 may include a validity period of the sensing unit 10. Also, the reference information may include a risk level that is an evaluation index, event information for each risk level, critical information for each risk level, a critical time for each risk level, and critical change rate information for each risk level. Also, the temporary storage 43 may further store a use period of the sensing unit 10, the change information, a sensing time of the change information, and sensing change rate information of the change information according to the sensing time.

Also, the reference information may further include standard pattern information according to the critical information and a standard analysis time for the standard pattern information. Also, the temporary storage 43 may further store sensing pattern information according to the change information based on the standard analysis time.

Also, the characteristic information of the sensing unit 10 may further include unique information of the sensing unit 10. The unique information of the sensing unit 10 may include a unique characteristic and an error of the sensing unit 10. Also, the reference information may further include standard characteristic change information that is based on the unique information of the sensing unit 10. Also, the temporary storage 43 may further store sensing characteristic change information that varies according to a field characteristic.

The controller 50 calculates at least sensing change rate information among sensing change rate information of the change information according to the sensing time of the change information, the sensing pattern information according to the change information, and the sensing characteristic change information that varies according to the field characteristic, and analyzes and compares information based on the change information with the reference information.

In detail, the controller 50 may include an event manager 51 configured to compare the event information and the change information and to generate an event, a time counter 52 configured to calculate the use period of the sensing unit 10 and to count the sensing time of the change information according to occurrence of the event, a sensing value analyzer 61 configured to compare the critical information for each risk level and the change information and to determine a safety status according to the risk level, a sensing value change calculator 53 configured to calculate the sensing change rate information of the change information according to the sensing time, a sensing value change analyzer 62 configured to compare the critical change rate information for each risk level and the sensing change rate information and to analyze a stability status according to the risk level, and a validity period analyzer 64 configured to compare the validity period of the sensing unit 10 and the use period of the sensing unit 10 and to analyze the stability status according to the risk level.

Also, the controller 50 may further include a sensing pattern calculator 54 configured to calculate the sensing pattern information based on the standard analysis time and a sensing pattern analyzer 63 configured to compare the standard pattern information and the sensing pattern information and to analyze the stability status according to the risk level.

Also, the controller 50 may further include a sensing characteristic change calculator 56 configured to calculate the sensing characteristic change information that varies according to the field characteristic and a sensing characteristic change analyzer 65 configured to compare the standard characteristic change information and the sensing characteristic change information and to analyze the safety status according to the risk level.

In the foregoing description, the risk level may be divided using three items. The risk level may be divided into a first risk level corresponding to at least one of critical information, critical change rate information, and standard pattern information and a second risk level corresponding to standard characteristic change information. In an example embodiment of the present disclosure, the risk level may be divided into five stages for each type. However, without being limited thereto, the risk level may be variously set, such as two stages, three stages, and one of six stages to ten stages.

First, the first risk level may be divided into five stages based on at least one of the critical information, the critical change rate information, and the standard pattern information.

A first stage is a case in which a risk probability is 15% or less and represents a safe situation. A second stage is a case in which the risk probability is 30% or less and represents a situation in which a safety varies. A third stage is a case in which the risk probability is 45%˜55% or less and represents a situation close to a risk situation.

A fourth stage is a case in which the risk probability is 90% or less and represents a risk situation and a worker may go to a site and inspect a status and may also quickly report the risk situation to managers, workers, and related institutions. A fifth stage is a case in which a risk situation occurs and, in response to occurrence of an accident, it is possible to quickly report the risk situation to managers, workers, and related institutions such that emergency treatment may be quickly performed on the field.

For example, at the first risk level, the risk probability is evaluated based on a similarity between critical information and change information through comparison between the critical information and the change information. According to an increase in the similarity, the risk probability increases. According to a decrease in the similarity, the risk probability decreases.

As another example, at the first risk level, the risk probability is evaluated based on a similarity between critical change rate information and sensing change rate information through comparison between the critical change rate information and the sensing change rate information. According to an increase in the similarity, the risk probability increases. According to a decrease in the similarity, the risk probability decreases.

As another example, at the first risk level, the risk probability is evaluated based on a similarity between standard pattern information and sensing pattern information through comparison between the standard pattern information and the sensing pattern information. According to an increase in the similarity, the risk probability increases. According to a decrease in the similarity, the risk probability decreases.

In the case of one of the first stage to the third stage in the foregoing description, the risk level is determined to be included in a preset safety range and a safety signal is generated. Also, in the case of the fourth stage or the fifth stage, the risk level is determined to be out of the preset safety range and a risk signal is generated.

Second, the second risk level may be divided into five stages based on the standard characteristic change information.

A first stage is a case in which the risk probability is 10% or less and an abnormal rate of sensing characteristic change information that varies according to a field characteristic in response to unique information of the sensing unit 10 is 10% or less, and represents a normal situation. A second stage is a case in which the risk probability is 15%˜20% or less and the abnormal rate of the sensing characteristic change information that varies according to the field characteristic in response to the unique information of the sensing unit 10 is 15%˜20% or less, and represents a situation in which a normality varies.

In the case of the first stage or the second stage, the risk level is determined to be included in a preset safety range and a safety signal is generated. Also, in the case of one of the following third stage to fifth state, the risk level is determined to be out of the preset safety range and a risk signal is generated. Comparison and analysis between the sensing unit 10 and a standard sensor may be performed on the field.

The third stage is a case in which the risk probability is 25%˜30% or less and the abnormal rate of the sensing characteristic change information that varies according to the field characteristic in response to the unique information of the sensing unit 10 is 25%˜30% or less, and represents a situation that enters an abnormal condition. When determined as the third stage, a state of the sensing unit 10 is verified on the field and the state of the sensing unit 10 is inspected through field comparison and analysis between the sensing unit 10 and the standard sensor and then, if a problem is found between the standard sensor and the sensing unit, the sensing unit is replaced. Here, when the first risk level is determined as the first stage or the second stage as a result of the field comparison and analysis, the sensing unit 10 is determined to be normal. When the first risk level is determined as one of the third stage to the fifth stage, the sensing unit 10 is determined to malfunction.

The fourth stage is a case in which the risk probability is 35%˜40% or less and the abnormal rate of the sensing characteristic change information that varies according to the field characteristic in response to the unique information of the sensing unit 10 is 35%˜40% or less and represents an abnormal situation. When determined as the fourth stage, the state of the sensing unit 10 needs to be inspected on the field and field comparison and analysis between the sensing unit 10 and the standard sensor may be performed and whether to replace the smart sensor 100 may be determined according to a result of the field comparison and analysis. Here, when the first risk level is determined as the first stage or the second stage as a result of the field comparison and analysis, the sensing unit 10 is determined to be normal. When the first risk level is determined as one of the third stage to the fifth stage, the sensing unit 10 is determined to malfunction.

The fifth stage is a case in which the risk probability is 45% or more and the abnormal rate of the sensing characteristic change information that varies according to the field characteristic in response to the unique information of the sensing unit 10 is 45% or more and represents as a malfunction situation of the sensing unit 10. When determined as the fifth stage, the state of the sensing unit 10 should be inspected on the field to unconditionally replace the sensing unit 10 on the field.

In particular, in the foregoing description, the risk signal is transmitted to the server 300 such that a follow-up action for the related sensing unit 10 may be quickly performed. Although not illustrated, the safety signal may be transmitted to the server 300 such that a state of the related sensing unit 10 may be stably monitored.

At the second risk level, the risk probability is evaluated based on a similarity between standard characteristic change information and sensing characteristic change information through comparison between the standard characteristic change information and the sensing characteristic change information. According to an increase in the similarity, the risk probability decreases. According to a decrease in the similarity, the risk probability increases.

The controller 50 may further include a target setting unit 66 configured to determine priority for analysis for at least two sensing units 10. The controller 50 may extract information stored in the sensor characteristic unit 41 and the reference storage 42 based on the sensing unit 10 selected by the target setting unit 66, and each of calculators and analyzers in the controller 50 may perform calculation and comparison and analysis based on the corresponding sensing unit 10.

The controller 50 may further include a sensing abnormality counter 57 configured to count abnormality frequency of the sensing characteristic change information for a use period. The sensing abnormality counter 57 may clarify the sensing characteristic change information in response to the abnormality frequency and enables field inspection to be performed according to the abnormality frequency.

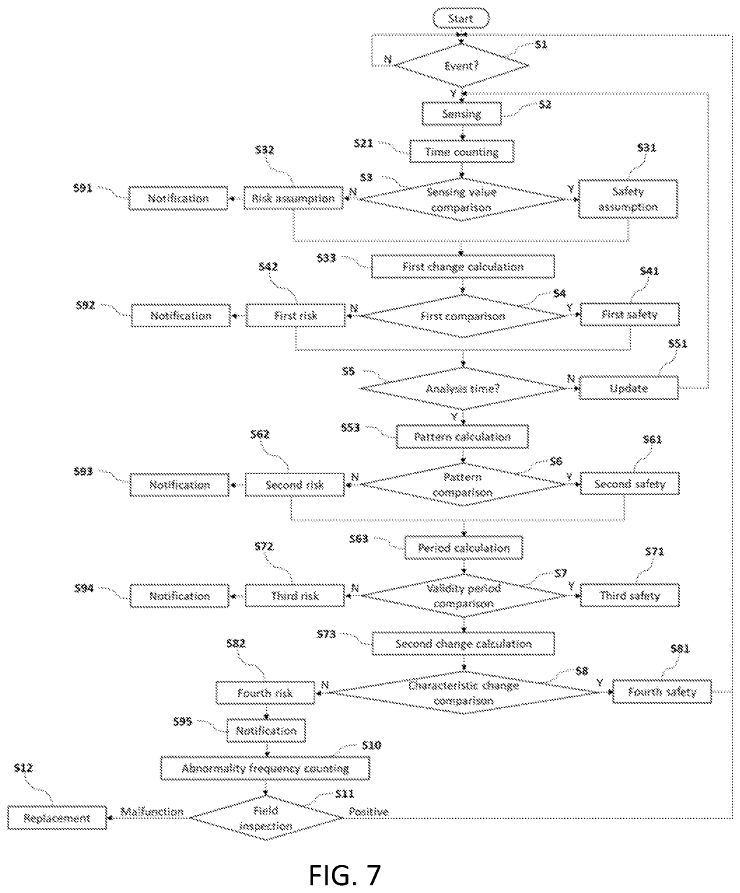

Hereinafter, a smart sensing method according to an example embodiment of the present disclosure is described with reference to FIG. 7.

The smart sensing method according to the example embodiment of the present disclosure is a smart sensing method using the smart sensor 100 according to an example embodiment of the present disclosure and includes sensing operation S2 of collecting change information on the field through the sensing unit 10, time counting operation S21 of counting sensing time of the change information by going through sensing operation S2, sensing value comparison operation S3 of comparing critical information for each risk level in reference information and the change information, first change calculation operation S33 of calculating sensing change rate information of the change information according to the sensing time after going through sensing value comparison operation S3, first comparison operation S4 of comparing critical change rate information for each risk level in the reference information and the sensing change rate information, period calculation operation S63 of calculating a use period of the sensing unit 10 after going through first comparison operation S4, and period comparison operation S7 of comparing a validity period of the sensing unit 10 in characteristic information of the sensing unit 10 and the use period of the sensing unit 10.

When the risk level is included in a preset safety assumption range as a comparison result of sensing value comparison operation S3, the smart sensing method according to an example embodiment may generate a temporary safety signal (S31) and may perform first change calculation operation S33.

Also, when the risk level is included in a preset first safety range as a comparison result of first comparison operation S4, the smart sensing method according to an example embodiment of the present invention may generate a first safety signal (S41) and may perform period calculation operation S63.

Also, when the use period of the sensing unit 10 is included in the validity period of the sensing unit 10 in the characteristic information of the sensing unit 10 as a comparison result of period comparison operation S7, the smart sensing method according to an example embodiment of the present disclosure may generate a third safety signal (S71) and may return to sensing operation S2.

Also, prior to sensing operation S2, the smart sensing method according to an example embodiment of the present disclosure may further include event operation S1 of monitoring an occurrence status of an event in response to event information for each risk level that is an evaluation index in the reference information. Here, when the event occurs as the change information is included in the event information as a result of event operation S 1, the smart sensing method performs sensing operation S2. Also, unless the event occurs as the result of event operation 51, the smart sensing method continues to repeatedly perform event operation 51.

Also, when the risk level is out of the preset safety assumption range as the comparison result of sensing value comparison operation S3, the smart sensing method according to an example embodiment of the present disclosure may generate a temporary risk signal (S32) and may perform first change calculation operation S33. The temporary risk signal may be transmitted to the server 300 (S91) to be managed in the server 300.

Also, when the risk level is out of the preset first safety range as the comparison result of first comparison operation S4, the smart sensing method according to an example embodiment of the present disclosure may generate a first risk signal (S42) and may perform period calculation operation S63. The first risk signal may be transmitted to the server 300 (S92) to be managed in the server 300.

Also, when the use period of the sensing unit 10 is out of the validity period of the sensing unit 10 in the characteristic information of the sensing unit 10 as the comparison result of period comparison operation S7, the smart sensing method according to an example embodiment of the present disclosure may generate a third risk signal (S72). The third risk signal may be transmitted to the server 300 (S94) to be managed in the server 300.

When at least one of the temporary risk signal, the first risk signal, and the third risk signal is generated (S32, S42, S72), a corresponding risk signal may be transmitted to the server 300 that communicates with the smart sensor 100 according to an example embodiment of the present disclosure (S91, S92, S94) and accordingly, the server 300 may monitor the smart sensor 100.

Also, the smart sensing method according to an example embodiment of the present disclosure may further include time verification operation S5 of comparing the standard analysis time for the standard pattern information according to the critical information and the sensing time of the change information after going through first comparison operation S4, pattern calculation operation S53 of, when the sensing time of the change information is greater than or equal to the standard analysis time as a comparison result of time verification operation S5, calculating the sensing pattern information according to the change information based on the standard analysis time, and pattern comparison operation S6 of comparing the standard pattern information and the sensing pattern information after going through pattern calculation operation S53.

When the risk level is included in a preset second safety range as a comparison result of pattern comparison operation S6, the smart sensing method according to an example embodiment of the present disclosure may generate a second safety signal (S61) and may perform period calculation operation S63.

Also, when the sensing time of the change information is less than the standard analysis time as a comparison result of time verification operation S5, the smart sensing method according to an example embodiment of the present disclosure may update and store the change information collected according to time series (S51) and then return to sensing operation S2.

By returning to sensing operation S2, the sensing time is counted while continuously collecting the change information.

Also, when the risk level is out of the preset second safety range as the comparison result of pattern comparison operation S6, the smart sensing method according to an example embodiment of the present disclosure may generate a second risk signal (S62) and may perform period calculation operation S63. The second risk signal may be transmitted to the server 300 (S93) to be managed in the server 300.

Here, when the second risk signal is generated, the corresponding risk signal is transmitted to the server 300 that communicates with the smart sensor 100 (S93) and accordingly, the server 300 may monitor the smart sensor 100.

Also, the smart sensing method according to an example embodiment of the present disclosure may further include second change calculation operation S73 of calculating the sensing characteristic change information that varies according to the field characteristic after going through period comparison operation S7 and characteristic change comparison operation S8 of comparing the standard characteristic change information and the sensing characteristic change information after going through second change calculation operation S73.

When the risk level is included in a preset fourth safety range as a comparison result of characteristic change comparison operation S8, the smart sensing method according to an example embodiment of the present disclosure may generate a fourth safety signal (S81) and may return to sensing operation S2 or event operation Si that is an initial operation. By returning to sensing operation S2 or event operation S1, the temporary storage 43 may be initialized and new information may be stored in the temporary storage 43. Although not illustrated, information of the temporary storage 43 may be transmitted to the server 300 to manage the smart sensor 100 in the server 300, prior to initialization.

Also, when the risk level is out of the preset fourth safety range as the comparison result of characteristic change comparison operation S8, the smart sensing method according to an example embodiment of the present disclosure may generate a fourth risk signal (S82) and may further include field inspection operation S11 of inducing field inspection. The fourth risk signal may be transmitted to the server 300 (S95) to be managed in the server 300.

In field inspection operation S11, the state of the sensing unit 10 may be verified on the field, field comparison and analysis between the sensing unit 10 and the standard sensor may be performed, and whether to replace the smart sensor 100 may be determined based on a result of the field comparison and analysis.

Here, when the sensing unit 10 is in a positive state as a result of field inspection operation S11 (when the first risk level is determined as the first stage and the second stage as a result of the field comparison and analysis), the smart sensing method may return to sensing operation S2 or event operation 51 that is an initial stage, which is described above.

Also, when the sensing unit 10 is in a malfunctioning state as the result of field inspection operation S11 (when the first risk level is determined as one of the third stage to the fifth stage), the smart sensing method may replace at least the sensing unit 10 in the smart sensor 100 on the field (S12). Once at least the sensing unit 10 is replaced, the smart sensing method may initialize the smart sensor 100 and may collect the change information using the new sensing unit 10 by returning to sensing operation S2 or event operation S1.

Also, the smart sensing method according to an example embodiment of the present disclosure may further include abnormality counting operation S10 of counting abnormality occurrence frequency prior to field inspection operation S11. Such counted abnormality occurrence frequency may be transmitted to the server 300 and may be used as bigdata to manage the smart sensor 100.

Although not illustrated, safety signals generated in the foregoing description may be transmitted to the server 300 and used to monitor the smart sensor 100 in the server 300.

The server 300 may manage information collected for the smart sensor 100 as bigdata, may update the reference information, and may transmit the same to the smart sensor 100.

A smart sensing method according to another example embodiment of the present disclosure may include sensing operation S2, time counting operation S21, sensing value comparison operation S3, first change calculation operation S33, first comparison operation S4, time verification operation S5, pattern calculation operation S53, and pattern comparison operation S6.

The smart sensing method according to another example embodiment of the present disclosure may further include period calculation operation S63 and period comparison operation S7.

The smart sensing method according to another example embodiment of the present disclosure may further include second change calculation operation S73 and characteristic change comparison operation S8.

An operation or a detailed operation added to another example embodiment of the present disclosure is regarded to be substantially the same as each operation described in an example embodiment of the present disclosure.

According to the aforementioned smart sensor and smart sensing method using the same, it is possible to quickly determine a malfunction diagnosis, a risk, and a normal situation in a sensor itself.

Also, since a simple algorithm is configured and applied to a sensor itself, it is possible to quickly respond to a situation.

Also, contextual information according to a situational response may be transmitted to the server 300 with an excellent computing ability and the server 300 may match the contextual information to information transmitted from another server and may precisely determine the contextual information accordingly.

Also, it is possible to quickly determine a malfunction diagnosis, a risk, and a normal situation in a sensor itself based on critical information for each risk level, critical change rate information for each risk level, and a validity period of the sensing unit 10 through a detailed configuration of the sensing storage 40 and the controller 50.

Also, it is possible to improve judgement power of a sensor itself based on standard pattern information added through a detailed configuration of the sensing storage 40 and the controller 50.

Also, it is possible to improve judgement power of a sensor itself based on standard characteristic change information added through a detailed configuration of the sensing storage 40 and the controller 50.

Also, it is possible to clearly determine a situation in a sensor itself by determining priority in change information collected by at least two sensing units 10 through the target setting unit 66.

Also, it is possible to count abnormality of sensing characteristic change information and to induce smooth inspection on the field through the sensing abnormality counter 57.

Also, since sequential comparison and analysis is performed based on critical information for each risk level, critical change rate information for each risk level, and a validity period of the sensing unit 10, it is possible to quickly determine a normal situation in a sensor itself in response to a safety signal.

Also, since event operation Si is further included, it is possible to clarify sensing operation S2 for comparison and analysis in a sensor itself and to prevent an operation of the sensor itself from being deteriorated.

Also, since sequential comparison and analysis is performed based on critical information for each risk level, critical change rate information for each risk level, and a validity period of the sensing unit 10, it is possible to quickly determine a malfunction diagnosis and a risk situation in a sensor itself and to perform a rapid propagation in response to a safety signal.

Also, since sequential comparison and analysis is performed based on standard pattern information, it is possible to improve judgement power for a normal situation in a sensor itself in response to a safety signal.

Also, it is possible to stably collect change information in time series order to correspond to a standard analysis time and to stabilize collection of change information according to a risk level.

Also, since sequential comparison and analysis is performed based on standard pattern information, it is possible to improve judgement power for a malfunction diagnosis and a risk situation in a sensor itself in response to a safety signal.

Also, since sequential comparison and analysis is performed based on standard characteristic change information, it is possible to improve judgement power for a normal situation in a sensor itself in response to a safety signal.

Also, since sequential comparison and analysis is performed based on standard characteristic change information, it is possible to improve judgement power for a malfunction diagnosis and a risk situation in a sensor itself in response to a risk signal.

Also, it is possible to count abnormality of sensing characteristic change information through abnormality frequency counting operation S10 and to induce smooth inspection on a field.

Also, it is possible to facilitate replacement in response to a malfunction of at least the sensing unit 10 based on a result of a field inspection operation and to maintain at least the sensing unit 10 in a stable normal condition.

Although the example embodiments of the present disclosure have been described with reference to the drawings, those skilled in the art may understand that various alterations or modifications may be made to the present disclosure without departing from the spirit and scope of the present disclosure as set forth in the following claims.

EXPLANATION OF SYMBOLS

| 100: smart sensor | 200: gateway | 300: server |
|---|---|---|
| 10: sensing unit | 20: communicator | 30: display |
| 40: sensing storage | 41: sensor characteristic unit | 42: reference storage |
| 43: temporary storage | 50: controller | 51: event manager |
| 52: time counter | 53: sensing value change calculator | 54: sensing pattern calculator |
| 56: sensing characteristic change calculator | 57: sensing abnormality counter | |
| 61: sensing value analyzer | 62: sensing value change analyzer | |
| 63: sensing pattern analyzer | 64: validity period analyzer | |
| 65: sensing characteristic change analyzer | 66: target setting unit | |
| S1: event operation | S2: sensing operation | S21: time counting operation |
| S3: sensing value comparison operation | S31: safety assumption operation | S32: risk assumption operation |
| S33: first change calculation operation | S4: first comparison operation | S41: first safety operation |
| S42: first risk operation | S5: time verification operation | S51: update operation |
| S53: pattern calculation operation | S6: pattern comparison operation | S61: second safety operation |
| S62: second risk operation | S63: period calculation operation | S7: validity period comparison operation |
| S71: third safety operation | S72: third risk operation | S73: second change calculation operation |
| S8: characteristic change comparison operation | S81: fourth safety operation | S82: fourth risk operation |

S91, S92, S93, S94, S95: notification operations

| | | |
|---|---|---|
| S10: abnormality counting operation | S11: field inspection operation | S12: replacement operation |

1. A smart sensor comprising:
at least one sensing unit configured to collect change information on a field;
a communicator configured to transmit the collected change information in time series order;
a sensing storage configured to store characteristic information of the sensing unit, reference information that is a target to be compared with information based on the characteristic information or the change information, and the change information; and
a controller configured to calculate at least sensing change rate information among the sensing change rate information of the change information according to a sensing time of the change information, sensing pattern information according to the change information, and sensing characteristic change information that varies according to field characteristic, and to analyze and compare information based on the change information with the reference information.

2. The smart sensor of claim 1, wherein the sensing storage comprises:
a sensor characteristic unit configured to store the characteristic information of the sensing unit, the characteristic information of the sensing unit including a validity period of the sensing unit;
a reference storage unit configured to store the reference information, the reference information including a risk level that is an evaluation index, event information for each risk level, critical information for each risk level, a critical time for each risk level, and critical change rate information for each risk level; and
a temporary storage configured to store a use period of the sensing unit, the change information, the sensing time of the change information, and the sensing change rate information of the change information according to the sensing time,
wherein the controller comprises:
an event manager configured to compare the event information and the change information and to generate an event;
a time counter configured to calculate the use period of the sensing unit and to count the sensing time of the change information according to occurrence of the event;
a sensing value analyzer configured to compare the critical information for each risk level and the change information and to determine a safety status according to the risk level;
a sensing value change calculator configured to calculate the sensing change rate information of the change information according to the sensing time;
a sensing value change analyzer configured to compare the critical change rate information for each risk level and the sensing change rate information and to analyze a stability status according to the risk level; and
a validity period analyzer configured to compare the validity period of the sensing unit and the use period of the sensing unit and to analyze the stability status according to the risk level.

3. The smart sensor of claim 2, wherein the reference information further includes standard pattern information according to the critical information and a standard analysis time for the standard pattern information, and
the temporary storage is configured to further store the sensing pattern information according to the change information based on the standard analysis time, and
the controller further comprises:
a sensing pattern calculator configured to calculate the sensing pattern information based on the standard analysis time; and
a sensing pattern analyzer configured to compare the standard pattern information and the sensing pattern information and to analyze the stability status according to the risk level.

4. A smart sensing method using the smart sensor according to claim 1, the smart sensing method comprising:
a sensing operation of collecting the change information on the field through the sensing unit;
a time counting operation of counting the sensing time of the change information by going through the sensing operation;
a sensing value comparison operation of comparing the critical information for each risk level in the reference information and the change information;
a first change calculation operation of calculating the sensing change rate information of the change information according to the sensing time after going through the sensing value comparison operation;
a first comparison operation of comparing the critical change rate information for each risk level in the reference information and the sensing change rate information;
a period calculation operation of calculating the use period of the sensing unit after going through the first comparison operation; and
a period comparison operation of comparing the validity period of the sensing unit in the characteristic information of the sensing unit and the use period of the sensing unit,
wherein, when the risk level is included in a preset safety assumption range as a comparison result of the sensing value comparison operation, a temporary safety signal is generated and the first change calculation operation is performed,
when the risk level is included in a preset first safety range as a comparison result of the first comparison operation, a first safety signal is generated and the period calculation operation is performed, and
when the use period of the sensing unit is included in the validity period of the sensing unit in the characteristic information of the sensing unit as a comparison result of the period comparison operation, a third safety signal is generated and returning to the sensing operation is performed.

5. The smart sensing method of claim 4, wherein, when the risk level is out of the preset safety assumption range as the comparison result of the sensing value comparison operation, a temporary risk signal is generated and the first change calculation operation is performed,
when the risk level is out of the preset first safety range as the comparison result of the first comparison operation, a first risk signal is generated and the period calculation operation is performed,
when the use period of the sensing unit is out of the validity period of the sensing unit in the characteristic information of the sensing unit as the comparison result of the period comparison operation, a third risk signal is generated, and
when at least one risk signal among the temporary risk signal, the first risk signal, and the third risk signal is generated, a corresponding risk signal is transmitted to a server that communicates with the smart sensor.

6. The smart sensing method of claim 4, further comprising:
a time verification operation of comparing the standard analysis time for the standard pattern information according to the critical information and the sensing time of the change information after going through the first comparison operation;
a pattern calculation operation of, when the sensing time of the change information is greater than or equal to the standard analysis time as a comparison result of the time verification operation, calculating the sensing pattern information according to the change information based on the standard analysis time; and
a pattern comparison operation of comparing the standard pattern information and the sensing pattern information after going through the pattern calculation operation,
wherein, when the risk level is included in a preset second safety range as a comparison result of the pattern comparison operation, a second safety signal is generated and the period calculation operation is performed.
